(19) United States
(12) Patent Application Publication
(10) Pub. No.: US 2013/0067932 A1
(43) Pub. Date: Mar. 21, 2013

(54) COMBUSTION SECTIONS OF GAS TURBINE ENGINES WITH CONVECTION SHIELD ASSEMBLIES

(71) Applicant: Don Tillman, Fountain Hills, AZ (US)

(72) Inventor: Don Tillman, Fountain Hills, AZ (US)

(73) Assignee: HONEYWELL INTERNATIONAL INC., Morristown, NJ (US)

(21) Appl. No.: 13/237,685

(22) Filed: Sep. 20, 2011

(51) Int. Cl. F02C 7/24; F01D 25/14

(52) U.S. Cl. 60/806; 415/178

(57) ABSTRACT

A combustion section is provided for a gas turbine engine. The combustion section includes a first liner; a second liner forming a combustion chamber with the first liner, the combustion chamber configured to receive an air-fuel mixture for combustion therein; a first case circumscribing the first liner and forming a first plenum with the first liner; and a convection shield assembly positioned between the first liner and the first case.

### STATEMENT REGARDING FEDERALLY SPONSORED RESEARCH OR DEVELOPMENT

This invention was made with Government support under DTFAWA-10-C-00040 awarded by the FAA. The Government has certain rights in the invention.

### TECHNICAL FIELD

The following description generally relates to gas turbine engines, and more particularly relates to temperature control of cases within the combustion section of gas turbine engines.

### BACKGROUND

A gas turbine engine may be used to power various types of vehicles and systems. A particular type of gas turbine engine that may be used to power aircraft is a turbofan gas turbine engine. A turbofan gas turbine engine conventionally includes, for example, five major sections: a fan section, a compressor section, a combustor section, a turbine section, and an exhaust section. The fan section is typically positioned at the inlet section of the engine and includes a fan that induces air from the surrounding environment into the engine and accelerates a fraction of this air toward the compressor section. The remaining fraction of air induced into the fan section is accelerated into and through a bypass plenum and out the exhaust section.

The compressor section raises the pressure of the air it receives from the fan section, and the resulting compressed air then enters the combustor section, where a ring of fuel nozzles injects a steady stream of fuel into a combustion chamber formed between inner and outer liners. The fuel and air mixture is ignited to form combustion gases, which drive rotors in the turbine section for power extraction. The gases then exit the engine at the exhaust section.

Known combustors include inner and outer liners positioned within inner and outer cases. The inner and outer liners define an annular combustion chamber in which the fuel and air mixture is combusted. The inner liner and inner case define an inner plenum adjacent to one side of the combustion chamber, and the outer liner and outer case define an outer plenum adjacent to the other side of the combustion chamber. During operation, a portion of the airflow entering the combustion section is channeled through the plenums in an attempt to cool the liners and to subsequently enter the combustion chamber through the liners. Although the air within the plenums is cool relative to the liners and the combustion chamber, the temperature of the plenum air may cause issues for the cases surrounding the liners. Over time, these elevated temperatures relative to the cases may result in thermal stresses and strains and other issues in the cases.

Accordingly, it is desirable to provide combustion sections having improved temperature control, particularly with respect to the combustor cases. Furthermore, other desirable features and characteristics of the present invention will become apparent from the subsequent detailed description of the invention and the appended claims, taken in conjunction with the accompanying drawings and this background of the invention.

### BRIEF SUMMARY

In accordance with an exemplary embodiment, a combustion section is provided for a gas turbine engine. The combustion section includes a first liner; a second liner forming a combustion chamber with the first liner, the combustion chamber configured to receive an air-fuel mixture for combustion therein; a first case circumscribing the first liner and forming a first plenum with the first liner; and a convection shield assembly positioned between the first liner and the first case.

In accordance with another exemplary embodiment, an engine section includes combustion section with a first combustion liner; and a second combustion liner forming a combustion chamber with the first combustion liner, the combustion chamber configured to receive an air-fuel mixture for combustion therein; a turbine section configured to receive combustion gases produced within the combustion chamber; a first case circumscribing the first combustion liner and at least a portion of the turbine section, the first case forming a first plenum with the first combustion liner and the turbine section; and a convection shield assembly positioned between the first combustion liner and turbine section and the first case.

### BRIEF DESCRIPTION OF THE DRAWINGS

The present invention will hereinafter be described in conjunction with the following drawing figures, wherein like numerals denote like elements, and

FIG. 1 is a cross-sectional view of a gas turbine engine in accordance with an exemplary embodiment;

FIG. 2 is a cross-sectional view of an engine section in the gas turbine engine of FIG. 1 in accordance with an exemplary embodiment;

FIG. 3 is a cross-sectional view of an outer convection shield assembly and outer case of the engine section of FIG. 2 in accordance with an exemplary embodiment; and

FIG. 4 is a partial, more-detailed cross-sectional view of the outer convection shield assembly and outer case of FIG. 3 in accordance with an exemplary embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Broadly, exemplary embodiments discussed herein relate to gas turbine engines with combustion sections. A combustion section includes a convection shield assembly interposed between the outer combustor case and the outer combustor liner. The convection shield assembly protects the combustor case from the high temperature air flowing through the plenums during operation.

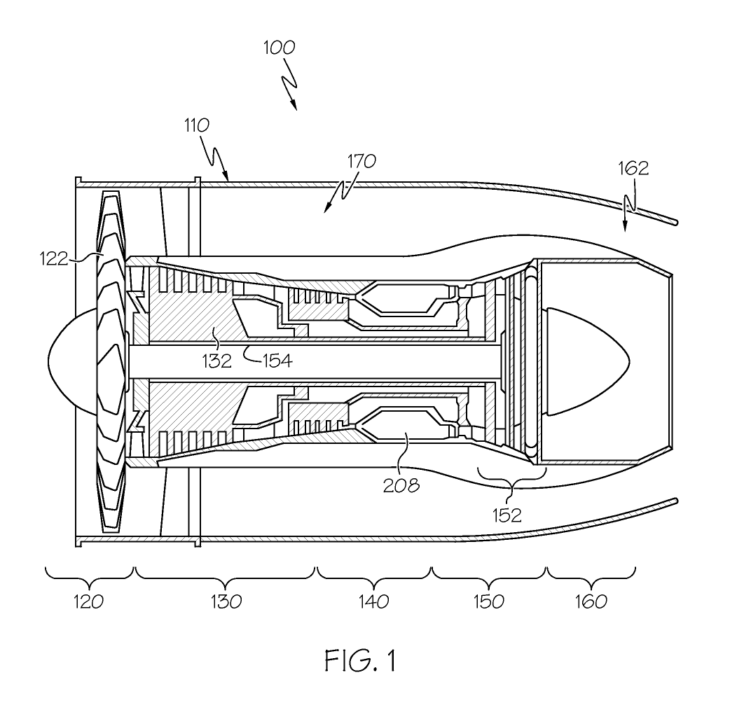

FIG. 1 is a cross-sectional view of a gas turbine engine 100 according to an exemplary embodiment. The gas turbine engine 100 can form part of, for example, an auxiliary power unit for an aircraft or a propulsion system for an aircraft. The gas turbine engine 100 may be disposed in an engine nacelle 110 and may include a fan section 120, a compressor section 130, a combustion section 140, a turbine section 150, and an exhaust section 160.

The fan section 120 may include a fan 122, which draws in and accelerates air. A fraction of the accelerated air exhausted from the fan 122 is directed through a bypass section 170 to provide a forward thrust. The remaining fraction of air exhausted from the fan 122 is directed into the compressor section 130.

The compressor section 130 may include a series of compressors 132, which raise the pressure of the air directed into it from the fan 122. The compressors 132 may direct the compressed air into the combustion section 140. In the combustion section 140, which includes an annular combustor 208, the high pressure air is mixed with fuel and combusted. The combusted air is then directed into the turbine section 150. As described in greater detail below, the combustion section 140 may include convection shield assemblies that protect combustor cases from the elevated temperatures associated with the air from the compressor section 130.

The turbine section 150 may include a series of turbines 152, which may be disposed in axial flow series. The combusted air from the combustion section 140 expands through the turbines 152 and causes them to rotate. The air is then exhausted through a propulsion nozzle 162 disposed in the exhaust section 160, providing additional forward thrust. In one embodiment, the turbines 152 rotate to thereby drive equipment in the gas turbine engine 100 via concentrically disposed shafts or spools. Specifically, the turbines 152 may drive the compressor 132 via one or more shafts 154.

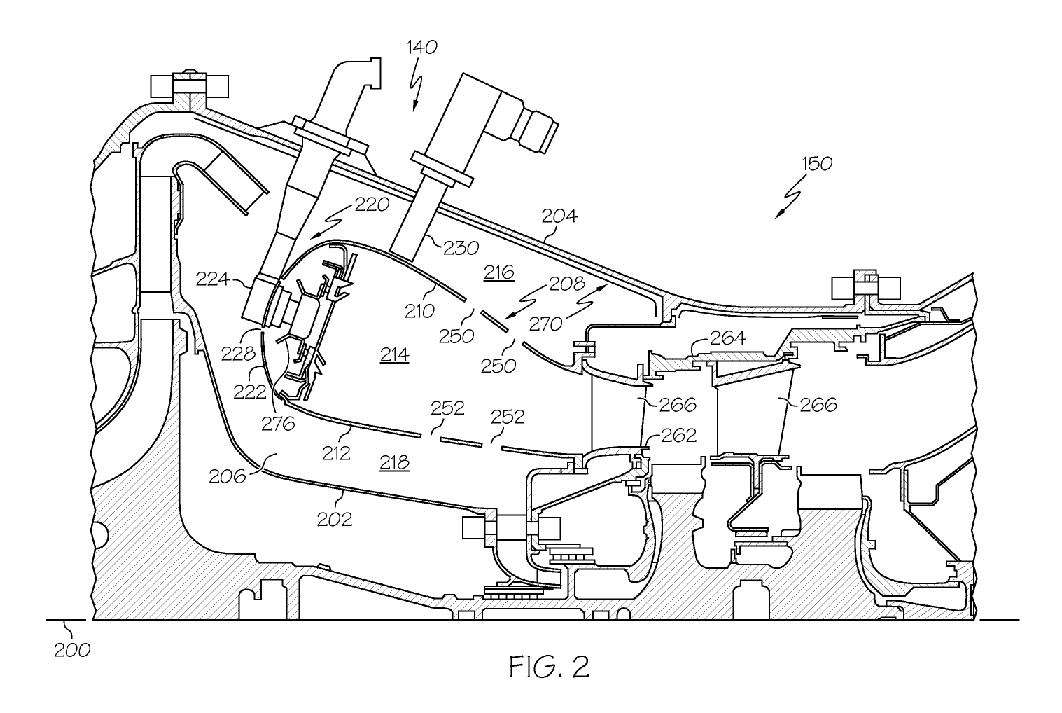

FIG. 2 is a more detailed cross-sectional view of the combustion section 140 of FIG. 1. A portion of the turbine section 150 is also shown downstream of the combustion section 140 (e.g., collectively forming an engine section). In FIG. 2, only half the cross-sectional view is shown, the other half being substantially rotationally symmetric about a centerline and axis of rotation 200, which additionally generally defines radial and axial directions. Although the depicted combustion section 140 is an annular-type combustion section, any other type of combustor, such as a can combustor, can be provided. The depicted combustion section 140 may be, for example, a rich burn, quick quench, lean burn (RQL) combustor section.

The combustion section 140 comprises a radially inner case 202 and a radially outer case 204 concentrically arranged with respect to the inner case 202. The inner and outer cases 202 and 204 circumscribe the axially extending engine centerline 200 to define an annular pressure vessel 206. As noted above, the combustion section 140 also includes the combustor 208 residing within the annular pressure vessel 206.

The combustor 208 is defined by an outer liner 210 and an inner liner 212 that is circumscribed by the outer liner 210 to define an annular combustion chamber 214. The liners 210 and 212 cooperate with and are aligned relative to one another within cases 202 and 204 to define respective outer and inner air plenums 216 and 218. In particular, the outer liner 210 and outer case 204 define the outer plenum 216, and the inner liner 212 and the inner case 202 define the inner plenum 218.

The inner liner 212 and outer liner 210 may be dual-walled liners or single-walled liners. The outer liner 210 and inner liner 212 may include one or more air admission holes 250 and 252 for admitting air into the combustion chamber 214 to support the combustion process. Although not shown, the outer liner 210 and inner liner 212 may further include effusion cooling holes for admitting a layer of air on the interior surfaces of the outer and inner liners 210 and 212 (e.g., within the combustion chamber 214).

The combustor 208 additionally includes a front end assembly 220 with a shroud assembly 222, fuel injectors 224, and fuel injector guides 226. One fuel injector 224 and one fuel injector guide 226 are shown in the partial cross-sectional view of FIG. 2. In one embodiment, the combustor 208 includes a number of circumferentially distributed fuel injectors 224. Each fuel injector 224 is secured to the outer case 204 and projects through a shroud port 228. Each fuel injector 224 introduces a swirling, intimately blended fuel and air mixture that supports combustion in the combustion chamber 214. A fuel igniter 230 extends through the outer case 204 and the outer plenum 216 and is coupled to the outer liner 210. It will be appreciated that more than one igniter 230 can be provided in the combustor 208, although only one is illustrated in FIG. 2. The igniter 230 is arranged downstream from the fuel injector 224 and is positioned to ignite the fuel and air mixture within the combustion chamber 214.

During engine operation, a flow of air from the compressor section 130 (FIG. 1) exits a high pressure diffuser and deswirler at a relatively high velocity and is directed into the annular pressure vessel 206 of the combustor 208. The compressed air flows through the plenums 216 and 218 and subsequently into the combustion chamber 214 through openings in the liners 210 and 212. For example, a portion of the compressed air may enter the combustion chamber 214 at relatively upstream positions as primary air and another portion of the compressed air may enter the combustion chamber 214 at relatively downstream positions as dilution air. A portion of the air flowing through the plenums 216 and 218 may also be used to cool the liners 210 and 212. For example, air flowing through the plenums 216 and 218 may be used for impingement and/or effusion cooling of the liners 210 and 212.

As described above, the air in the combustion chamber 214 is mixed with fuel from the fuel injector 224 and combusted after being ignited by the igniter 230. The combusted air exits the combustion chamber 214 and is delivered to the turbine section 150.

The turbine section 150 generally includes a turbine flow path for receiving the combustion air from the combustion chamber 214. The turbine flow path may be defined by inner platforms 262 and an outer turbine shroud 264 that radially confine the combustion air as it is directed through airfoils 266 for energy extraction. As is shown in FIG. 2, the outer case 204 and the outer plenum 216 additionally circumscribe at least a portion of the turbine section 150, for example, the turbine shroud 264.

As will now be described in greater detail, the combustion section 140 further includes convection shield assembly 270. In one exemplary embodiment, a convection shield assembly 270 is mounted adjacent to the outer case 204 to protect the outer case 204 from the gases within the outer plenum 216. Although not shown, in some embodiments, another (or inner) convection shield assembly may be mounted adjacent to the inner case 202 to protect the inner case 202 from the gases within the inner plenum 218

As noted above, air enters the combustion section 140 through the plenums 216 and 218 prior to flowing through the liners 210 and 212 and into the combustion chamber 214. Although the air in the plenums 216 and 218 has a relatively lower temperature than the combusted air within the combustion chamber 214, the plenum air may still have a higher temperature than recommended for the case 204. For example, in some combustion sections 140, the case 204 is titanium, and the plenum air may have temperatures of around 1000° F. Extended exposure to such temperatures may cause undesirable issues for some cases 204. This is particularly an issue with the plenum air, which may have high velocity, high density, and high pressure, thereby resulting in relatively high heat transfer coefficients. However, as described below, the convection shield assembly 270 provides protection for the case 202 from the plenum air. In one exemplary embodiment, the convection shield assembly 270 may be formed from HASTX, Inconel718, or Inconel1625.

During operation, the convection shield assembly 270 isolates the case 204 from the plenum air to prevent convective heat transfer between the plenum air and the case 204. Generally, convective heat transfer is the transfer of heat from one component to another by the movement of fluids, such as air, which is in contrast to thermal radiation and/or conductive heat transfer. For example, in one exemplary embodiment, the combustion liners of the engine may be about 1200° F. and the plenum air will be about 1000° F. In one example, even without the convection shield assembly, the radiation transfer between the liners and cases in such a scenario would be negligible, although the convective heat transfer between the case and plenum air would be an issue. However, according to the exemplary embodiments discussed herein, the convection shield assembly 270 isolates the case 204 from the plenum air to prevent convective heat transfer between the plenum air and the case 204.

As also shown in FIG. 2 and referenced above, a portion of the outer case 204 extends beyond the forward end of the turbine section 150. As such, the convection shield assembly 270 also extends beyond the forward end of the turbine section 150 to protect the case 204 from the temperature of the plenum air in this section as well.

In some embodiments, the convection shield assembly 270 may enable the case 204 to maintain temperatures of more than 100° F. or 200° F. less than the temperature of the plenum air. Collectively, the convection shield assembly 270 and case 204 may have a thermal resistance that is approximately two orders of magnitude greater than a case 204 has on its own. As a result, the manufacturing, design, and operating options for the combustion section 140 are enhanced. For example, the case 204 may be manufactured from a lighter material, such as titanium, which may not otherwise have the durability characteristics of heavier materials, such as steel or nickel alloys. As another example, the combustion section 140 may be able to operate at higher temperatures than previous operating limits. Additional details of the shield assembly 270 are discussed below.

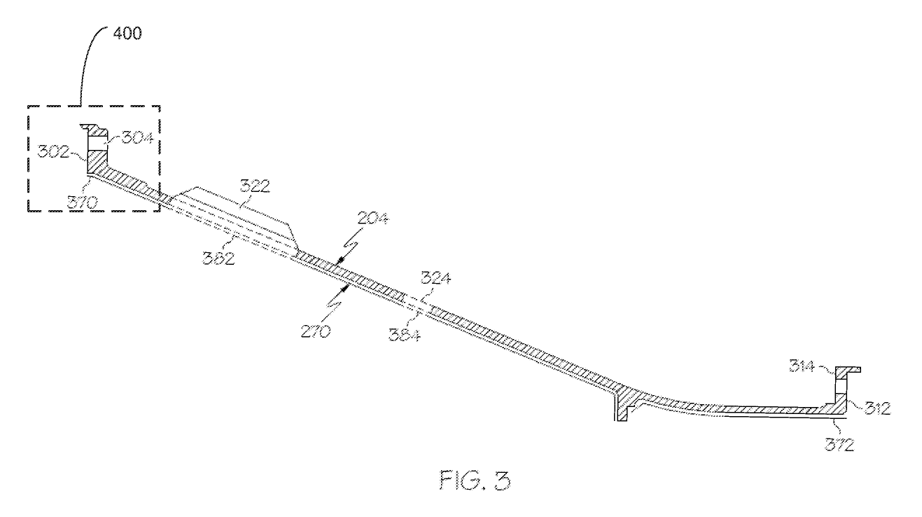

FIG. 3 is a cross-sectional view of the convection shield assembly 270 and outer case 204 of the combustion section 140 of FIG. 2 in accordance with an exemplary embodiment. The outer case 204 generally extends in an axial direction and is typically an annular structure. A first end 302 includes a radial flange 304 for coupling to the compressor section 130 (FIG. 1), and a second end 312 includes another radial flange 314 for coupling to the turbine section 150 (FIG. 1). Openings 322 and 324 (one of each is shown in FIG. 2) are defined in the outer case 204 to respectively accommodate the fuel injector 224 and fuel igniter 230 (FIG. 2). Other flanges, protrusions, and/or openings may be provided as necessary or desired to accommodate other components of the combustion section 140.

The convection shield assembly 270 has a shape that generally mirrors that of the outer case 204. As such, the convection shield assembly 270 generally extends in an axial direction and is typically an annular structure. In particular, the convection shield assembly 270 extends from a first (or forward) end 370 adjacent the first end 302 of the outer case 204 to a second (or aft) end 372 adjacent the second end 312 of the outer case 204. Additionally, the convection shield assembly 270 may have openings 382 and 384 that match the openings 322 and 324 in the outer case 204. In one exemplary embodiment, the convection shield assembly 270 may be continuous except for portions that accommodate flanges, protrusions, and/or openings in the outer case 204. In other embodiments, the convection shield assembly 270 may be in sections or tiles.

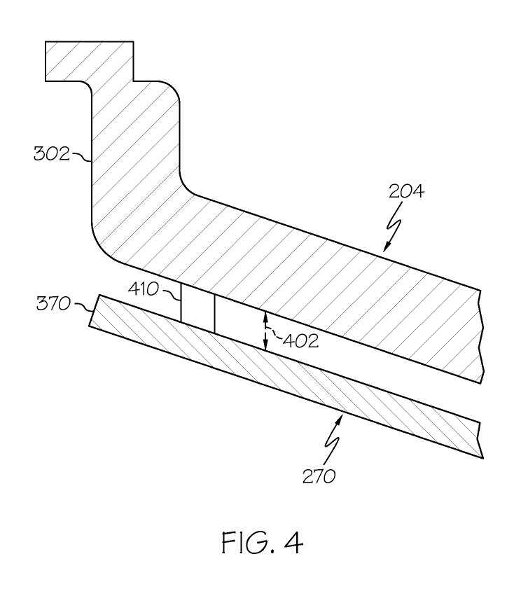

Reference is additionally made to FIG. 4, which is a partial, more-detailed cross-sectional view of the convection shield assembly 270 and outer case 204 of FIG. 3 in accordance with an exemplary embodiment. In particular, FIG. 4 is a view at the first end 302 of the outer case 204. As shown, the convection shield assembly 270 is offset from the outer case 204 by a distance 402. The distance 402 is relatively small, although sufficient to at least partially prevent convective heat transfer from the plenum air to the outer case 204. In exemplary embodiments, the distance 402 is greater than zero, although, for example, less than an inch, less than half an inch, or less than a tenth of an inch. In another exemplary embodiment, the distance 402 may be, for example, about 0.02 inches. Due to the relatively small distance 402 between the outer case 204 and the convection shield assembly 270, the convection shield assembly 270 generally does not interfere with the aerodynamic properties of the plenum air and particularly does not interfere with the cooling arrangements for the liners 210.

The convection shield assembly 270 may be mounted on the outer case 204 in any suitable manner. In the example shown by FIG. 4, the convection shield assembly 270 is mounted on the outer case 204 with a bolt 410. In some embodiments, the mounting arrangements may enable thermal growth or contraction of the convection shield assembly 270, particularly in an axial direction. Other installation mechanisms may also be provided. For example, an axi-symmetric slot or local tabs may be provided at each end of the convection shield assembly 270 to cooperate with tabs or flanges in the case 204.

Accordingly, exemplary embodiments discussed herein provide improved thermal management of the combustion sections of gas turbines engines. The convection shield assemblies enable operating conditions with higher temperatures and/or increased durability for the combustion cases in a cost-effective and reliable manner, for example, without complicated active mechanical arrangements and/or without heavy or expensive components. Different configurations and arrangements of the shield assemblies may be provided as necessary in dependence on the desired temperature of the respective case. For example, although an annular combustor section is described above, the convection shield assemblies may be used with other combustor arrangements, such as can combustors. Exemplary embodiments may find beneficial uses in many industries, including aerospace and particularly in high performance aircraft, as well as automotive and electrical generation.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A combustion section for a gas turbine engine, comprising:
a first liner;
a second liner forming a combustion chamber with the first liner, the combustion chamber configured to receive an air-fuel mixture for combustion therein;
a first case circumscribing the first liner and forming a first plenum with the first liner; and
a convection shield assembly positioned between the first liner and the first case, wherein the first case is offset from the convection shield assembly by a first distance, the first distance being less than 0.1 inches.

2. The combustion section of claim 1, wherein the first liner is an outer liner and the first case is an outer case.

3. The combustion section of claim 1, wherein the convection shield assembly is mounted on the first case.

4. The combustion section of claim 1, wherein the first plenum is configured to receive air from a compressor as plenum air and wherein the convection shield assembly is configured to substantially shield the first case from the plenum air.

5. The combustion section of claim 4, wherein the first liner is configured to admit the plenum air into the combustion chamber.

6. (canceled)

7. The combustion section of claim 1, wherein the first distance is about 0.02 inches.

8. The combustion section of claim 1, wherein the first case includes a first case end configured to be coupled to a compressor section and a second case end configured to be coupled to a turbine section, and wherein the convection shield assembly includes a first shield end positioned proximate to the first case end and a second shield end positioned proximate to the second case end.

9. The combustion section of claim 8, wherein the convection shield assembly extends into the turbine section.

10. The combustion section of claim 1, wherein, during operation, the first liner operates at a first temperature and the first case operates at a second temperature, and wherein the convection shield assembly reduces convective heat transfer between the first liner and the first case such that the second temperature is at least 100° F. less than the first temperature.

11. An engine section, comprising:
a combustion section, comprising
a first combustion liner; and
a second combustion liner forming a combustion chamber with the first combustion liner, the combustion chamber configured to receive an air-fuel mixture for combustion therein;
a turbine section configured to receive combustion gases produced within the combustion chamber;
a first case circumscribing the first combustion liner and at least a portion of the turbine section, the first case forming a first plenum with the first combustion liner and the turbine section; and
a convection shield assembly positioned between the first combustion liner and turbine section and the first case, wherein the first case is offset from the convection shield assembly by a first distance, the first distance being less than 0.1 inches.

12. The engine section of claim 11, wherein the first combustion liner is an outer combustion liner and the first case is an outer case.

13. The engine section of claim 11, wherein the convection shield assembly is mounted on the first case.

14. The engine section of claim 11, wherein the first plenum is configured to receive air from a compressor as plenum air and wherein the convection shield assembly is configured to substantially shield the first case from the plenum air.

15. The engine section of claim 11, wherein the first combustion liner is configured to admit the plenum air into the combustion chamber.

16. (canceled)

17. The engine section of claim 11, wherein the first distance is about 0.02 inches.

18. The engine section of claim 11, wherein the first case includes a first case end configured to be coupled to a compressor section and a second case end configured to be coupled to a downstream turbine case, and wherein the convection shield assembly includes a first shield end positioned proximate to the first case end and a second shield end positioned proximate to the second case end.

19. The engine section of claim 11, wherein the convection shield assembly extends into the turbine section.

20. The engine section of claim 11, wherein, during operation, the first liner operates at a first temperature and the first case operates at a second temperature, and wherein the convection shield assembly reduces convective heat transfer between the first liner and the first case such that the second temperature is at least 100° F. less than the first temperature.
